(19) United States
(12) Patent Application Publication
(10) Pub. No.: US 2017/0091600 A1
(43) Pub. Date: Mar. 30, 2017

(54) INFORMATION PROCESSING APPARATUS, IMAGE FORMING SYSTEM, NON-TRANSITORY COMPUTER READABLE MEDIUM, AND INFORMATION PROCESSING METHOD

(71) Applicant: FUJI XEROX CO., LTD., Tokyo (JP)

(72) Inventor: Kenichiro HOTOKEISHI, Kanagawa (JP)

(73) Assignee: FUJI XEROX CO., LTD., Tokyo (JP)

(21) Appl. No.: 15/044,809

(22) Filed: Feb. 16, 2016

(30) Foreign Application Priority Data
Sep. 25, 2015 (JP) 2015-187933

(51) Int. Cl. G06K 15/02; G06F 3/12

(52) U.S. Cl. CPC G06K 15/1859; G06K 15/022; G06K 15/1809; G06F 3/1205; G06F 3/1251; G06F 3/1281

(57) ABSTRACT

An information processing apparatus includes an image forming area setting unit and an output unit. In formation of an image on a first surface and a second surface of a recording medium, the setting unit sets a position of at least one image forming area on the second surface to be separated in a transport direction of the recording medium from an upstream end portion in the transport direction of the recording medium by a distance of a value obtained by subtracting from a length in the transport direction of the recording medium a distance in the transport direction from a downstream end portion in the transport direction of the recording medium to an upstream end portion in the transport direction of at least one image forming area on the first surface. The output unit outputs information representing the set position of the at least one image forming area.

### CROSS-REFERENCE TO RELATED APPLICATIONS

This application is based on and claims priority under 35 USC 119 from Japanese Patent Application No. 2015-187933 filed Sep. 25, 2015.

### BACKGROUND

(i) Technical Field

The present invention relates to an information processing apparatus, an image forming system, a non-transitory computer readable medium, and an information processing method.

(ii) Related Art

Printing systems in recent years employing continuous paper printers are capable of printing on both surfaces of paper at high speed when configured to connect the continuous paper printers together. Further, with different types of printers connected together, the printing systems switch between color printing and monochrome printing, for example, and perform printing in accordance with various types and sizes of paper.

### SUMMARY

According to an aspect of the invention, there is provided an information processing apparatus including an image forming area setting unit and an output unit. In formation of an image on a first surface of a recording medium and a second surface of the recording medium opposite to the first surface, the image forming area setting unit sets a position of at least one image forming area on the second surface for forming the image such that the at least one image forming area on the second surface is separated in a transport direction, in which the recording medium is transported when the image is formed on the first surface in an image forming apparatus that forms an image, from an upstream end portion in the transport direction of the recording medium by a distance corresponding to a value obtained by subtracting from a length in the transport direction of the recording medium a distance in the transport direction from a downstream end portion in the transport direction of the recording medium to an upstream end portion in the transport direction of at least one image forming area on the first surface for forming the image. The output unit outputs information representing the set position of the at least one image forming area.

### BRIEF DESCRIPTION OF THE DRAWINGS

An exemplary embodiment of the present invention will be described in detail based on the following figures, wherein:

FIG. 1 is a diagram illustrating an example of the configuration of a printing system;

FIG. 2 is a block diagram illustrating an example of the configuration of a client apparatus;

FIGS. 3A to 3C are diagrams illustrating an example of arrangement of print areas set on surfaces of paper;

FIG. 4 is a flowchart illustrating an example of an imposition process;

FIG. 5 is a diagram illustrating an example of an imposition template creation screen;

FIG. 6 is a diagram illustrating an example of arrangement of the print areas on the surfaces of the paper set on the imposition template creation screen illustrated in FIG. 5;

FIG. 7 is a diagram illustrating an example of the imposition template creation screen;

FIG. 8 is a diagram illustrating an example of arrangement of the print areas on the surfaces of the paper set on the imposition template creation screen illustrated in FIG. 7;

FIG. 9 is a block diagram illustrating an example of the configuration of a client apparatus;

FIG. 10 is a flowchart illustrating an example of the imposition process; and

FIG. 11 is a diagram illustrating a correspondence relationship between a print position and an origin position on a front surface or a back surface and a calculation formula of a print position on the back surface.

### DETAILED DESCRIPTION

An exemplary embodiment of the present invention will be described below with reference to the drawings.

### 1. Exemplary Embodiment

### 1-1. Configuration

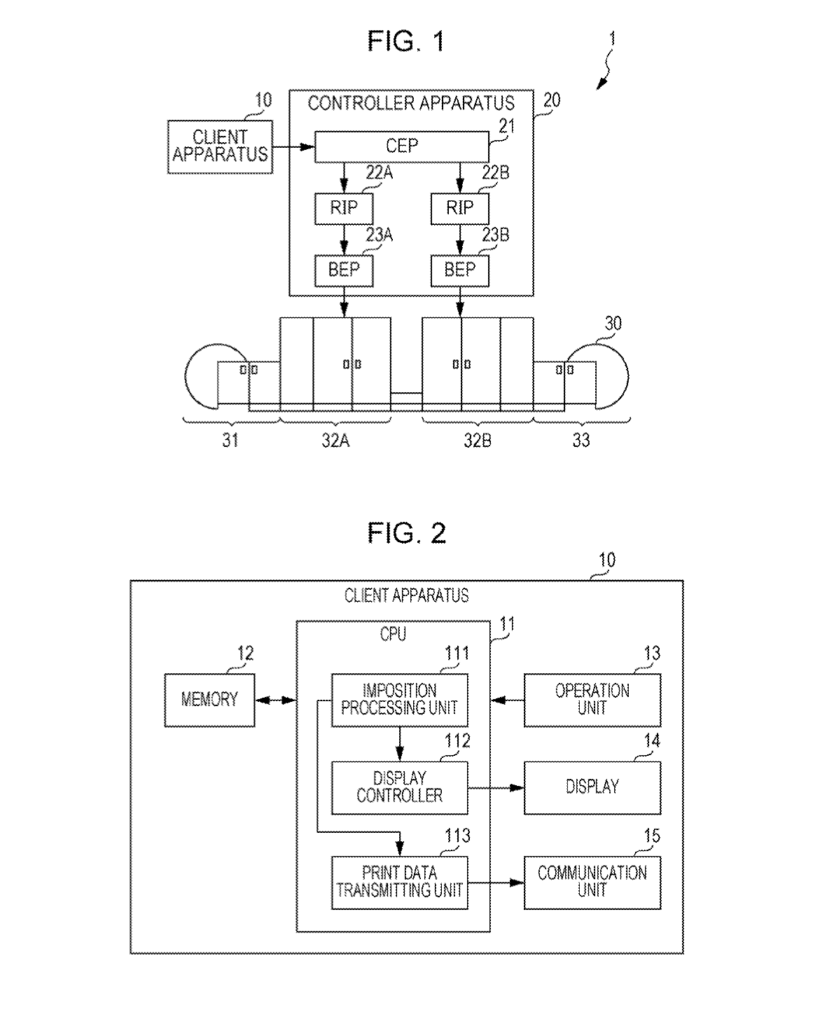

FIG. 1 is a diagram illustrating an example of the configuration of a printing system 1 according to an exemplary embodiment of the present invention. The printing system 1 is an example of an “image forming system” according to an exemplary embodiment of the invention. The printing system 1 is configured of a client apparatus 10, a controller apparatus 20, and a printer 30. The controller apparatus 20 is connected to the client apparatus 10 by a not-illustrated communication line, and is also connected to the printer 30 by a not-illustrated communication line. Herein, the communication line is a wireless or wired local area network (LAN), for example.

The client apparatus 10 is a computer apparatus that transmits a print instruction including print data to the controller apparatus 20. Specifically, the client apparatus 10 is a desktop computer, such as a personal computer, or a portable computer, such as a tablet terminal, a smartphone, or a mobile phone. In the present exemplary embodiment, the client apparatus 10 is an example of an “information processing apparatus” according to an exemplary embodiment of the invention. The print data transmitted from the client apparatus 10 is described in a page description language (abbreviated as PDL).

The controller apparatus 20 is a computer apparatus that receives the print instruction from the client apparatus 10, generates raster data based on the received print instruction, and transmits the raster data to the printer 30. The controller apparatus 20 includes a central processing unit (CPU) and a memory. The controller apparatus 20 has functions of a central processor (CEP) 21, raster image processors (RIPs) 22A and 22B, and back end processors (BEPs) 23A and 23B. These functions are implemented as the CPU executes a program stored in the memory.

Upon receipt of the print instruction from the client apparatus 10, the CEP 21 sends the RIP 22A print data included in the received print instruction and representing images to be formed on the front surface of paper, and sends the RIP 22B print data included in the received print instruction and representing images to be formed on the back surface of the paper.

The RIPs 22A and 22B interpret the print data acquired from the CEP 21, and generate intermediate data expressing images of respective pages represented by the print data. The RIPs 22A and 22B then transmit the generated intermediate data of the respective pages to the BEPs 23A and 23B, respectively. The RIP 22A generates intermediate data expressing the images to be formed on the front surface of the paper, and transmits the generated intermediate data to the BEP 23A. Meanwhile, the RIP 22B generates intermediate data expressing the images to be formed on the back surface of the paper, and transmits the generated intermediate data to the BEP 23B.

The BEPs 23A and 23B process the intermediate data of the respective pages acquired from the RIPs 22A and 22B, and generate raster data of the respective pages. The BEPs 23A and 23B then transmit the generated raster data to printing units 32A and 32B of the printer 30, respectively. The BEP 23A processes the intermediate data of the respective pages acquired from the RIP 22A, and generates and transmits raster data of the respective pages to the printing unit 32A. Meanwhile, the BEP 23B processes the intermediate data of the respective pages acquired from the RIP 22B, and generates and transmits raster data of the respective pages to the printing unit 32B.

The printer 30 is an image forming apparatus that forms an image on paper. Specifically, the printer 30 is a continuous paper printer. The printer 30 includes a preprocessing unit 31, the printing units 32A and 32B, and a postprocessing unit 33. The preprocessing unit 31 is an apparatus that stores and supplies continuous paper. The printing units 32A and 32B are apparatuses that form images on the paper. The image forming method employed is an inkjet method or an electrophotographic method, for example. The printing unit 32A forms images on the front surface of the paper based on the raster data supplied by the BEP 23A. Meanwhile, the printing unit 32B forms images on the back surface of the paper based on the raster data supplied by the BEP 23B. The postprocessing unit 33 is an apparatus that reels in and stores the continuous paper having the images formed thereon.

FIG. 2 is a block diagram illustrating an example of the configuration of the client apparatus 10. The client apparatus 10 includes a CPU 11, a memory 12, an operation unit 13, a display 14, and a communication unit 15. The CPU 11 executes a program stored in the memory 12 to implement later-described various functions. The memory 12 is a storage device, such as a hard disk drive or a flash memory. The operation unit 13 is an input device, such as a touch sensor or keys. The display 14 is a display device, such as a liquid crystal display. The communication unit 15 is a communication interface, such as a data communication card.

The CPU 11 has functions of an imposition processing unit 111, a display controller 112, and a print data transmitting unit 113. The imposition processing unit 111 is an example of an “image forming area setting unit” according to an exemplary embodiment of the invention. The display controller 112 and the print data transmitting unit 113 are an example of an “output unit” according to an exemplary embodiment of the invention.

The imposition processing unit 111 executes an imposition process on document data created by a user. Specifically, the imposition processing unit 111 lays out plural logical pages represented by the document data on a surface of paper forming a physical page. If n-up printing is performed in this process, the imposition processing unit 111 lays out the n number of logical pages on a single physical page. Herein, n-up printing refers to printing in which n (n represents an integer equal to or greater than 2) logical pages are arranged on a single physical page. Further, if duplex printing is performed in the process, the imposition processing unit 111 lays out the logical pages on both the front surface and the back surface of the paper. Herein, duplex printing refers to printing in which an image is formed on both the front surface and the back surface of paper. The imposition process performed by the imposition processing unit 111 will be described below with reference to drawings.

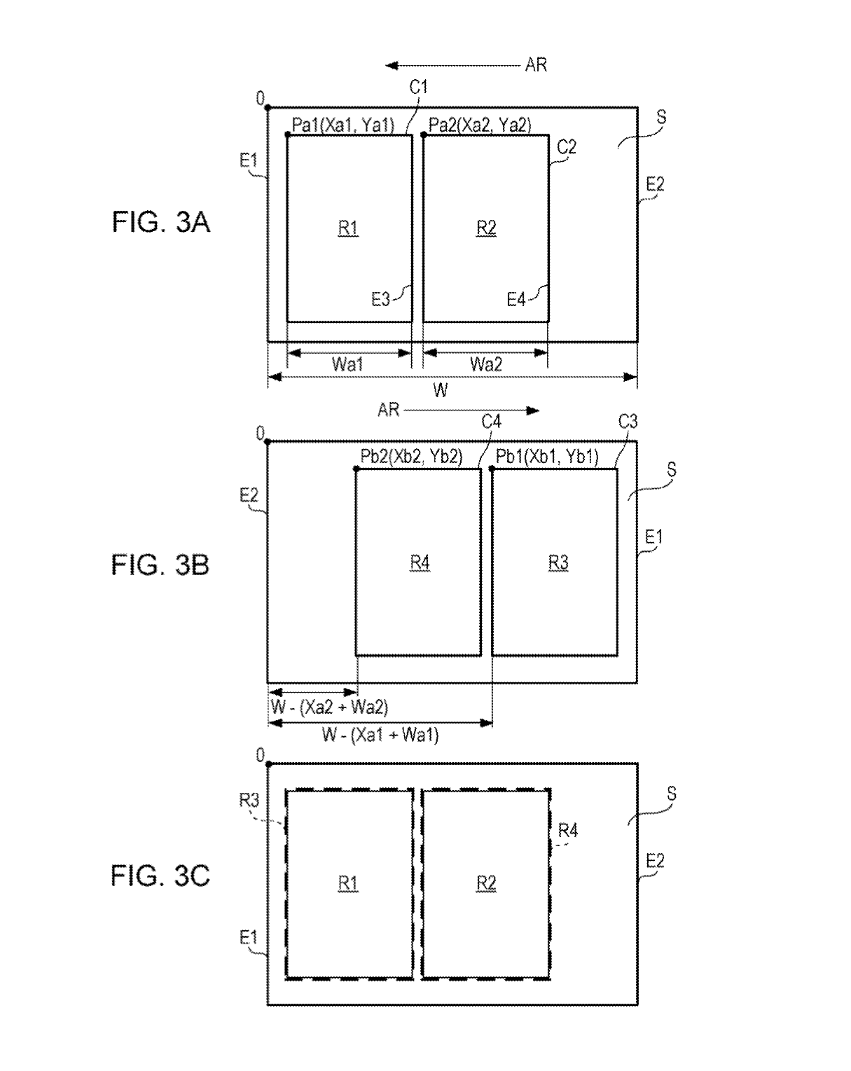

FIGS. 3A to 3C are diagrams illustrating an example of arrangement of print areas R set on surfaces of paper S. Herein, a print area R is an image forming area in which the image of a single logical page is formed. In FIGS. 3A and 3B, a print position P of the print area R is represented by an x-y coordinate system. The horizontal axis corresponds to the x-axis, and the vertical axis corresponds to the y-axis. An origin O is set at the upper-left corner on each of the front surface and the back surface of the paper S. An arrow AR illustrated in FIGS. 3A and 3B indicates the direction in which the paper S is transported when an image is formed on the front surface of the paper S in the printer 30 (hereinafter simply referred to as the “transport direction”). FIG. 3A illustrates the arrangement of print areas R on the front surface of the paper S. FIG. 3B illustrates the arrangement of print areas R on the back surface of the paper S. FIG. 3C illustrates the arrangement of the print areas R on the front surface of the paper S and the print areas R on the back surface of the paper S as seen through from the side of the front surface.

In duplex printing, the imposition processing unit 111 sets the position of the print area on the back surface based on the position of the print area on the front surface. In this process, the imposition processing unit 111 sets the position of the print area on the back surface such that the print area on the front surface and the print area on the back surface are superimposed on each other in the thickness direction of paper (that is, a direction perpendicular to the surfaces of the paper). More accurately, the imposition processing unit 111 sets the position of the print area on the back surface such that the outline of the print area on the front surface and the outline of the print area on the back surface are superimposed on each other in the thickness direction of the paper. For instance, in the example illustrated in FIGS. 3A to 3C, the position of a print area R3 on the back surface is set such that an outline C3 of the print area R3 is superimposed on an outline C1 of a print area R1 on the front surface in the thickness direction of the paper S. Further, the position of a print area R4 on the back surface is set such that an outline C4 of the print area R4 is superimposed on an outline C2 of a print area R2 on the front surface in the thickness direction of the paper S. In the example illustrated in FIGS. 3A to 3C, the print areas R on the front surface and the print areas R on the back surface have the relationship of mirror images, with right and left reversed.

When setting the position of the print area on the back surface based on the position of the print area on the front surface, the imposition processing unit 111 sets the position of the print area on the back surface such that the print area on the back surface is separated in the transport direction from an upstream end portion in the transport direction of the paper by a distance corresponding to the value obtained by subtracting from the length in the transport direction of the paper the distance from a downstream end portion in the transport direction of the paper to an upstream end portion in the transport direction of the print area on the front surface. For instance, in the example illustrated in FIGS. 3A to 3C, the position of the print area R3 on the back surface is set to be separated in the transport direction from an end portion E2 of the paper S by a distance (W−(Xa1+Wa1)) corresponding to the value obtained by subtracting from a length W of the paper S the distance from an end portion E1 of the paper S to an end portion E3 of the print area R1 on the front surface (Xa1+Wa1). Further, the position of the print area R4 on the back surface is set to be separated in the transport direction from the end portion E2 of the paper S by a distance (W−(Xa2+Wa2)) corresponding to the value obtained by subtracting from the length W of the paper S the distance from the end portion E1 of the paper S to an end portion E4 of the print area R2 on the front surface (Xa2+Wa2).

When setting the position of the print area on the back surface based on the position of the print area on the front surface, the imposition processing unit 111 sets a print position of the print area on the back surface to the position determined based on the value obtained by subtracting the length in the transport direction of the print area on the front surface from the value obtained by subtracting the value representing a print position of the print area on the front surface from the length in the transport direction of the paper. Herein, the print position is a reference position specifying the position in the transport direction of the print area. For instance, in the example illustrated in FIGS. 3A to 3C, a print position Xb1 of the print area R3 on the back surface is set to (W−(Xa1+Wa1)) represented by the value obtained by subtracting a length Wa1 of the print area R1 on the front surface from the value obtained by subtracting the value representing a print position Xa1 of the print area R1 on the front surface from the length W of the paper S. Further, a print position Xb2 of the print area R4 on the back surface is set to the position represented by a value (W−(Xa2+Wa2)) obtained by subtracting a length Wa2 of the print area R2 on the front surface from the value obtained by subtracting the value representing a print position Xa2 of the print area R2 on the front surface from the length W of the paper S.

Then, the display controller 112 causes the display 14 to display information representing the position of the print area on the back surface of the paper set by the imposition processing unit 111. Specifically, the display controller 112 causes the display 14 to display an image illustrating the arrangement of the print area set on the back surface of the paper.

The print data transmitting unit 113 generates print data in the PDL format based on the document data subjected to the imposition process by the imposition processing unit 111, and transmits the print data to the CEP 21. The print data contains the information representing the position of the print area on the back surface of the paper set by the imposition processing unit 111.

### 1-2. Operation

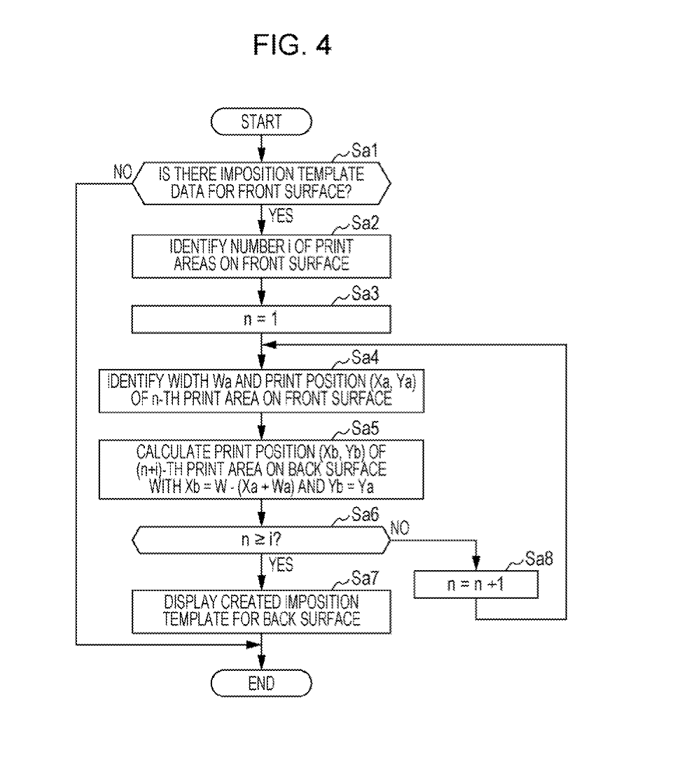

The imposition process executed by the imposition processing unit 111 of the client apparatus 10 will now be described with reference to a flowchart. FIG. 4 is a flowchart illustrating an example of the imposition process. The imposition process illustrated in FIG. 4 is executed upon pressing of a predetermined button on an imposition template creation screen, which is a screen for the user to lay out the pages of the document data on the surfaces of paper.

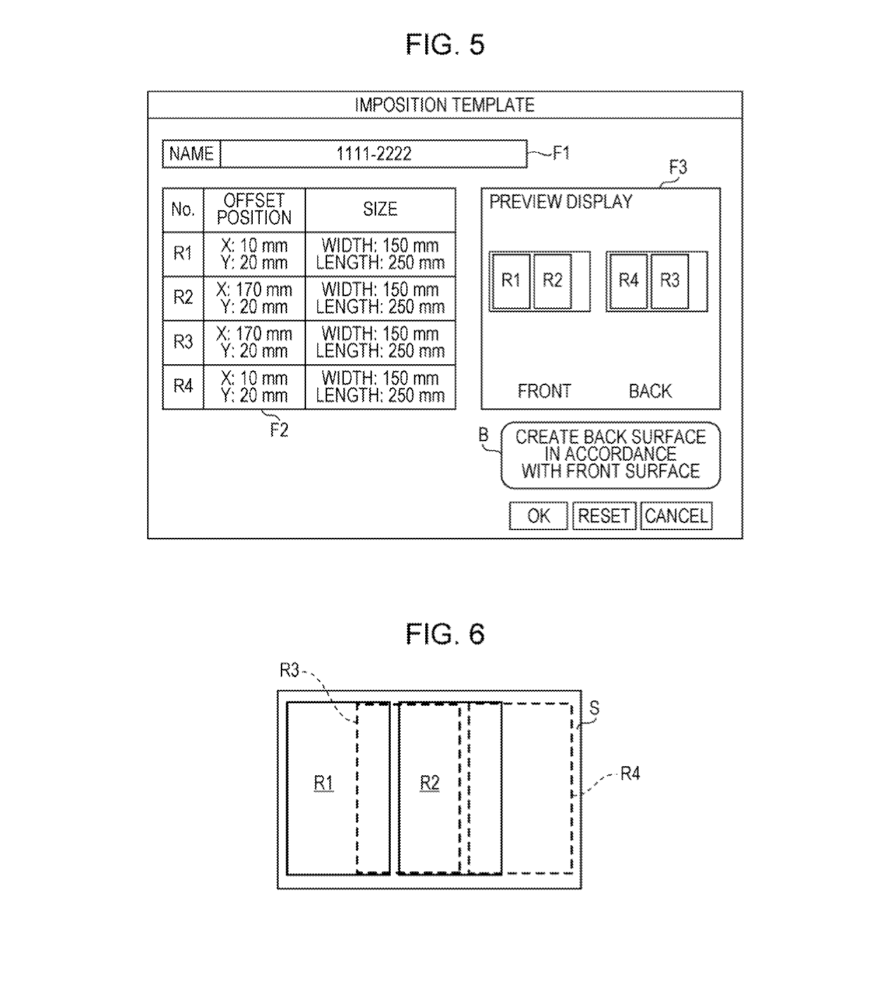

FIG. 5 is a diagram illustrating an example of the imposition template creation screen. The imposition template creation screen illustrated in FIG. 5 displays a template name setting field F1, a print area setting field F2, a preview display field F3, and an imposition process start button B. The template name setting field F1 is for setting the name of the template. The print area setting field F2 is for setting the offset position (that is, the print position) and the size of each of the print areas. The preview display field F3 is for displaying a preview of arrangement of the print areas on the paper. The imposition process start button B is for instructing to start the imposition process. FIG. 6 is a diagram illustrating an example of arrangement of the print areas R on the surfaces of the paper S set on the imposition template creation screen illustrated in FIG. 5. FIG. 6 specifically illustrates the arrangement of the print areas R on the front surface of the paper S and the print areas R on the back surface of the paper S as seen through from the side of the front surface. FIG. 6 indicates that, according to the settings of the imposition template illustrated in FIG. 5, the outline of the print area R3 on the back surface is not superimposed on the outline of the print area R1 on the front surface in the thickness direction of the paper S. FIG. 6 further indicates that the outline of the print area R4 on the back surface is not superimposed on the outline of the print area R2 on the front surface in the thickness direction of the paper S.

If the imposition process start button B is pressed on the imposition template creation screen illustrated in FIG. 5, the imposition processing unit 111 determines whether or not there is imposition template data for the front surface (step Sa1). If it is determined that there is no imposition template data for the front surface (NO at step Sa1), the present process is completed. Meanwhile, if it is determined that there is imposition template data for the front surface (YES at step Sa1), the imposition processing unit 111 proceeds to step Sa2. For instance, according to the example illustrated in FIG. 5, the offset position and the size are set for each of the print areas R1 and R2 on the front surface of the paper. Thus, the determination result at step Sa1 is positive.

At step Sa2, the imposition processing unit 111 identifies a number i of print areas on the front surface. For instance, according to the example illustrated in FIGS. 3A to 3C, “2” is identified as the number i of print areas on the front surface.

The imposition processing unit 111 then sets a variable n to “1” (step Sa3), and identifies a width Wa and a print position (Xa, Ya) of the n-th print area on the front surface (step Sa4). For instance, according to the example illustrated in FIGS. 3A to 3C, a width Wa1 and a print position Pa1 (Xa1, Ya1) of the “first” print area R1 are identified.

Then, the imposition processing unit 111 calculates a print position (Xb, Yb) of the (n+i)-th print area on the back surface based on the width Wa and the print position (Xa, Ya) of the n-th print area on the front surface identified at step Sa4 (step Sa5). At this step, the imposition processing unit 111 calculates the print position (Xb, Yb) with the following equations:

Xb=W−(Xa+Wa)

Yb=Ya

For instance, according to the example illustrated in FIGS. 3A to 3C, Pb1({W−(Xa1+Wa1)}, Ya1) is identified as a print position Pb1 (Xb1, Yb1) of the “third” print area R3.

The imposition processing unit 111 then determines whether or not any of the print areas on the front surface is not set to be subjected to the process. Specifically, the imposition processing unit 111 determines whether or not the variable n equals or exceeds the value i (step Sa6). If it is determined that the variable n falls below the value i (NO at step Sa6), the imposition processing unit 111 increments the variable n (step Sa8), and returns to step Sa4. Meanwhile, if it is determined that the variable n equals or exceeds the value i (YES at step Sa6), the display controller 112 causes the display 14 to display the imposition template for the back surface based on the print position of the print area on the back surface calculated at step Say (step Sa7). Thereafter, the present process is completed.

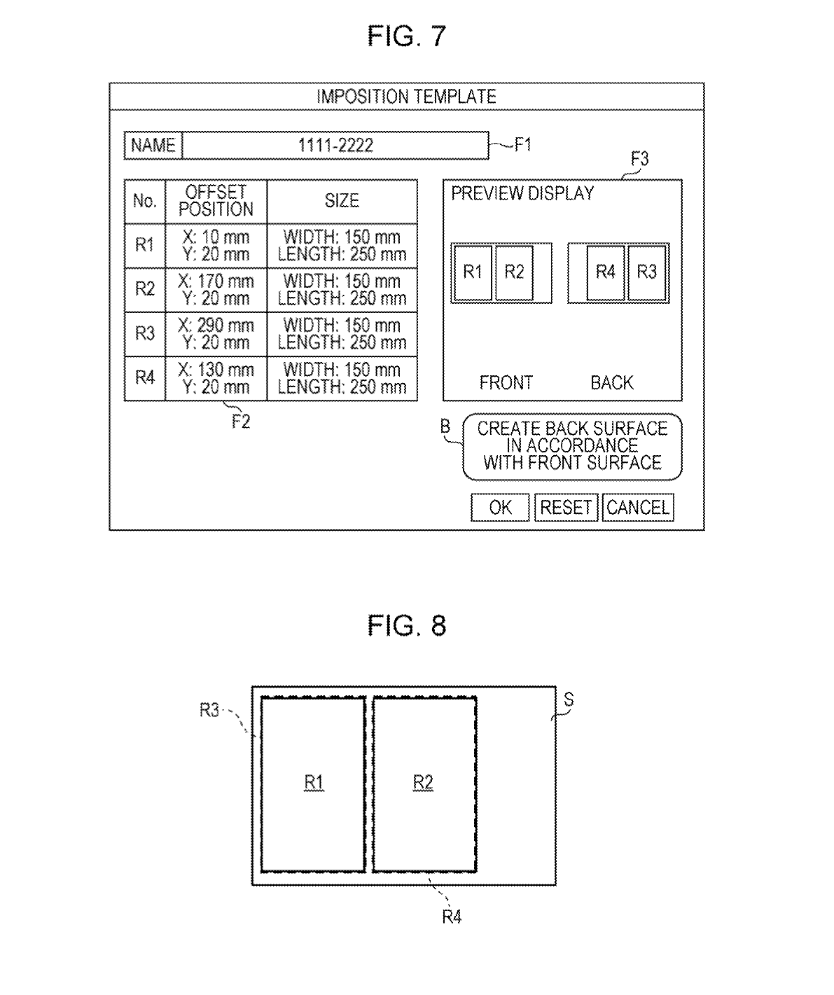

FIG. 7 is a diagram illustrating an example of the imposition template creation screen for the back surface displayed on the display 14. The offset positions of the print areas R3 and R4 in the example illustrated in FIG. 7 are different from those in the example illustrated in FIG. 5. Specifically, the x-coordinate of the offset position of the print area R3 is changed from “170 mm” to “290 mm.” Further, the x-coordinate of the offset position of the print area R4 is changed from “10 mm” to “130 mm.” In the example illustrated in FIG. 7, the length of the paper in the transport direction (that is, the x-axis direction) is assumed to be “450 mm.” FIG. 8 is a diagram illustrating an example of arrangement of the print areas R on the surfaces of the paper S set on the imposition template creation screen illustrated in FIG. 7. FIG. 8 specifically illustrates the arrangement of the print areas R on the front surface of the paper S and the print areas R on the back surface of the paper S as seen through from the side of the front surface. FIG. 8 indicates that, according to the settings of the imposition template illustrated in FIG. 7, the outline of the print area R3 on the back surface is superimposed on the outline of the print area R1 on the front surface in the thickness direction of the paper S. FIG. 8 further indicates that the outline of the print area R4 on the back surface is superimposed on the outline of the print area R2 on the front surface in the thickness direction of the paper S.

The foregoing is a description of the imposition process.

According to the above-described imposition process, the imposition template for the back surface according to the imposition template for the front surface is created simply by pressing of the imposition process start button B by the user. That is, the position of the print area on the back surface is set such that the print area on the back surface is superimposed on the print area on the front surface in the thickness direction of the paper.

### 2. Modified Examples

The foregoing exemplary embodiment may be modified as follows. Further, each of the following modified examples may be combined with one or more of the other modified examples.

### 2-1. First Modified Example

In the imposition process according to the foregoing exemplary embodiment, the length W in the transport direction of the paper referred to calculate the print position of the print area on the back surface may be set based on paper size information output from the printer 30. If the length W in the transport direction of the paper is set based on the length in the transport direction of the paper actually set in the printer 30, misalignment in superimposition of the print area on the front surface and the print area on the back surface is reduced as compared with a case in which the length W in the transport direction of the paper is set to a value predetermined by a program.

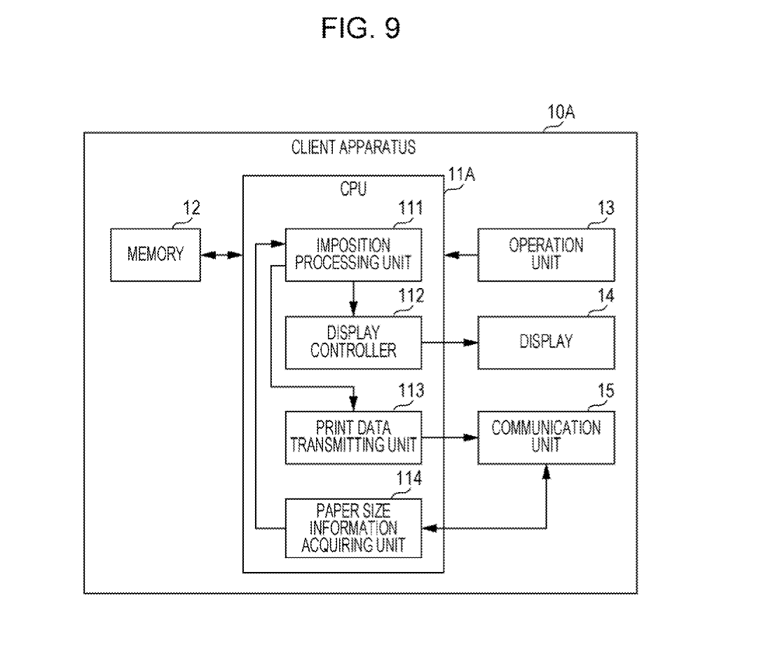

FIG. 9 is a block diagram illustrating an example of the configuration of a client apparatus 10A according to the present modified example. The client apparatus 10A illustrated in FIG. 9 is different from the client apparatus 10 illustrated in FIG. 2 in that a CPU 11A has a function of a paper size information acquiring unit 114. The paper size information acquiring unit 114 acquires information representing the length in the transport direction of the paper and output from the printer 30 that stores the paper. In the acquisition process, the paper size information acquiring unit 114 may acquire the information via the controller apparatus 20 or directly from the printer 30. Further, the paper size information acquiring unit 114 may acquire the information at predetermined periods or at a time specified by the user. For example, the paper size information acquiring unit 114 may acquire the information after the user presses the imposition process start button B and before step Sa1 is executed in the imposition process according to the foregoing exemplary embodiment. The paper size information acquiring unit 114 is an example of an “acquiring unit” according to an exemplary embodiment of the invention.

If the information representing the length in the transport direction of the paper has been acquired by the paper size information acquiring unit 114, the imposition processing unit 111 calculates, at step Say of the imposition process according to the foregoing exemplary embodiment, the print position of the print area on the back surface with the length in the transport direction of the paper represented by the acquired information. Meanwhile, if the information representing the length in the transport direction of the paper has not been acquired by the paper size information acquiring unit 114 for a reason such as the absence of the paper set in the printer 30, for example, the imposition processing unit 111 calculates, at step Say of the imposition process, the print position of the print area on the back surface with the length in the transport direction of the paper preset by a program.

### 2-2. Second Modified Example

The imposition process according to the foregoing exemplary embodiment may be executed by the controller apparatus 20 in place of the client apparatus 10. Specifically, the imposition process may be executed by the CEP 21 of the controller apparatus 20. The imposition process may be executed not in accordance with the instruction from the user of the client apparatus 10. A controller apparatus 20A according to the present modified example is an example of the “information processing apparatus” according to an exemplary embodiment of the invention.

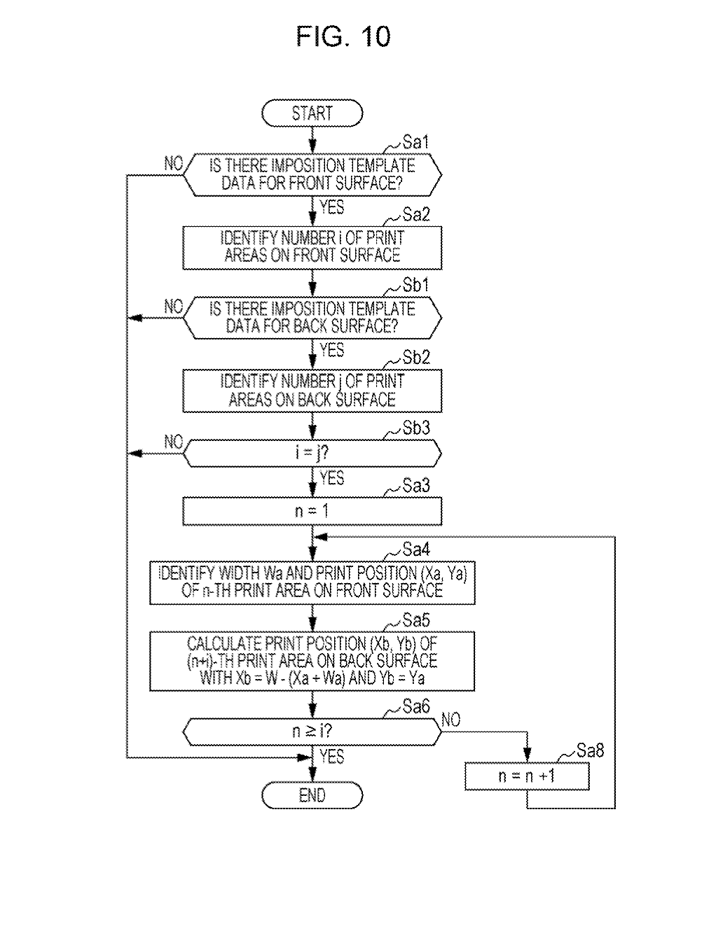

FIG. 10 is a flowchart illustrating an example of the imposition process according to the present modified example. The imposition process illustrated in FIG. 10 is executed upon receipt of the print data transmitted from the client apparatus 10 by a CEP 21A of the controller apparatus 20A. The present imposition process is executed by an imposition processing unit 111A included in the CEP 21A with reference to the received print data. The imposition processing unit 111A is an example of the “image forming area setting unit” according to an exemplary embodiment of the invention. The present imposition process is different from the imposition process illustrated in FIG. 4 in that steps Sb1 to Sb3 are added thereto and step Sa1 is omitted therefrom. The following description will be given only of the differences from the imposition process illustrated in FIG. 4.

At step Sb1 of the present imposition process, the imposition processing unit 111A determines whether or not there is imposition template data for the back surface by referring to the print data transmitted from the client apparatus 10. If it is determined that there is no imposition template data for the back surface (NO at step Sb1), the present process is completed. Meanwhile, if it is determined that there is imposition template data for the back surface (YES at step Sb1), the imposition processing unit 111A proceeds to step Sb2.

At step Sb2, the imposition processing unit 111A identifies a number j of print areas on the back surface. For instance, according to the example illustrated in FIGS. 3A to 3C, “2” is identified as the number j of print areas on the back surface.

The imposition processing unit 111A then determines whether or not the number i of print areas on the front surface identified at step Sa2 and the number j of print areas on the back surface identified at step Sb2 satisfy a predetermined condition (step Sb3). Herein, the predetermined condition is that the number i of print areas on the front surface and the number j of print areas on the back surface are equal. If it is determined that the number i of print areas on the front surface and the number j of print areas on the back surface are different (NO at step Sb3), the present process is completed. Meanwhile, if it is determined that the number i of print areas on the front surface and the number j of print areas on the back surface are equal (YES at step Sb3), the imposition processing unit 111A proceeds to step Sa3. That is, the imposition processing unit 111A sets the respective positions of the print areas on the back surface such that the print areas on the back surface are superimposed on the print areas on the front surface in the thickness direction of the paper.

If the imposition process exemplified in FIG. 10 is completed, the CEP 21A sends the RIP 22A print data subjected to the imposition process and representing images to be formed on the front surface of the paper, and sends the RIP 22B print data subjected to the imposition process and representing images to be formed on the back surface of the paper. Herein, the CEP 21A is an example of the “output unit” according to an exemplary embodiment of the invention.

### 2-3. Third Modified Example

The continuous paper stored in the printer 30 according to the foregoing exemplary embodiment is an example of a “recording medium” according to an exemplary embodiment of the invention. The recording medium may be cut paper. In this case, the printer 30 may be a printer compatible with cut paper. Further, the recording medium is not limited to paper, and may be a film made of a synthetic resin.

### 2-4. Fourth Modified Example

In the imposition process according to the foregoing exemplary embodiment, the front surface of the paper is an example of a “first surface” according to an exemplary embodiment of the invention. The first surface may be the back surface of the paper. That is, in the foregoing imposition process, the positions of the print areas on the front surface may be set such that the print areas on the front surface are superimposed on the print areas on the back surface in the thickness direction of the paper.

### 2-5. Fifth Modified Example

In the imposition process according to the foregoing exemplary embodiment, the image of the logical page represented by the document data is an example of an “image” according to an exemplary embodiment of the invention. The image formed in the print area of the paper may be the image of an object forming the logical page. Herein, the object is a character string, graphics (line art or a figure), an image (a continuous tone image), or the like.

### 2-6. Sixth Modified Example

In the foregoing example illustrated in FIGS. 3A to 3C, the entire outlines C of the print areas R on the front surface of the paper S and the entire outlines C of the print areas R on the back surface of the paper S are superimposed on each other in the thickness direction of the paper S. However, the entire outlines C of the print areas R on the front surface and the entire outlines C of the print areas R on the back surface are not necessarily required to be superimposed on each other. That is, it suffices if parts of the outlines C of the print areas R on the front surface and parts of the outlines C of the print areas R on the back surface are superimposed on each other. For example, if the sizes of the print areas R are different between the front surface and the back surface of the paper S, it suffices if the print positions of the print areas R on the front surface and print positions of the print areas R on the back surface are superimposed on each other in the thickness direction of the paper S. Further, although the number of print areas R is the same between the front surface and the back surface of the paper S in the foregoing example illustrated in FIGS. 3A to 3C, the number of print areas R is not necessarily required to be the same between the front surface and the back surface of the paper S. Further, although 2-up printing is performed in the foregoing example illustrated in FIGS. 3A to 3C, the number of logical pages laid out on a single physical page may be one, three, or more. Further, in the layout, the print areas may be laid out in a direction perpendicular to the transport direction. Further, the shape of the print areas may be other than the rectangular shape.

### 2-7. Seventh Modified Example

The client apparatus 10 according to the foregoing exemplary embodiment and the controller apparatus 20A according to the foregoing second modified example are examples of the “information processing apparatus” according to an exemplary embodiment of the invention. The information processing apparatus may also be the printer 30. That is, the printer 30 may have the function of the imposition processing unit 111.

### 2-8. Eighth Modified Example

Although the coordinates of the upper-left corner of each of the print areas R are set as the print position P in the foregoing example illustrated in FIGS. 3A to 3C, the coordinates of another point of the print area R may be set as the print position P. For example, the coordinates of the lower-left corner, the upper-right corner, or the lower-right corner of the print area R may be set as the print position P. Further, although the upper-left corner of the paper S is set as the origin O of the x-y coordinate system in the foregoing example illustrated in FIGS. 3A to 3C, another corner of the sheet S may be set as the origin O. For example, the lower-left corner, the upper-right corner, or the lower-right corner of the paper S may be set as the origin O.

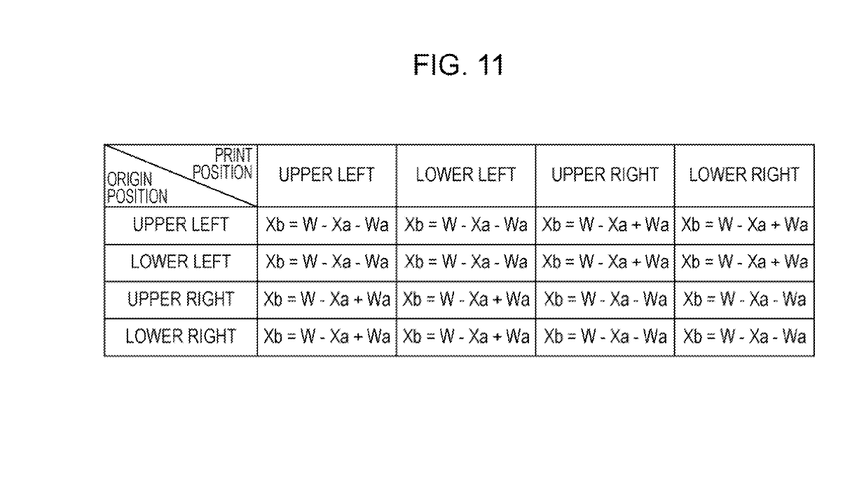

FIG. 11 is a diagram illustrating the correspondence relationship between the print position and the origin position on the front surface or the back surface and a calculation formula of the print position Xb on the back surface. As illustrated in FIG. 11, if the coordinates of the upper-right corner of the print area is set as the print position and the upper-left corner of the paper S is set as the origin O of the x-y coordinate system, the imposition processing unit 111 at step Say of the imposition process according to the foregoing exemplary embodiment calculates the print position Xb with the following equation:

Xb=W−Xa+Wa

That is, when setting the position of the print area on the back surface based on the position of the print area on the front surface, the imposition processing unit 111 sets the print position of the print area on the back surface to the position determined based on the value obtained by adding the length in the transport direction of the print area on the front surface to the value obtained by subtracting the value representing the print position of the print area on the front surface from the length in the transport direction of the paper. Herein, the print position is a reference position specifying the position in the transport direction of the print area.

Regardless of the print position and the position of the origin O, the print position Yb is calculated with the following equation:

Yb=Ya

### 2-9. Ninth Modified Example

The program executed by the CPU 11 of the client apparatus 10 according to the foregoing exemplary embodiment or a CPU of the controller apparatus 20A according to the foregoing second modified example may be provided as stored in a storage medium, such as a magnetic tape, a magnetic disk, a flexible disk, an optical disk, a magneto-optical disk, or a memory. Further, the program may be downloaded via a communication line, such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an image forming area setting unit that, in formation of an image on a first surface of a recording medium and a second surface of the recording medium opposite to the first surface, sets a position of at least one image forming area on the second surface for forming the image such that the at least one image forming area on the second surface is separated in a transport direction, in which the recording medium is transported when the image is formed on the first surface in an image forming apparatus that forms an image, from an upstream end portion in the transport direction of the recording medium by a distance corresponding to a value obtained by subtracting from a length in the transport direction of the recording medium a distance in the transport direction from a downstream end portion in the transport direction of the recording medium to an upstream end portion in the transport direction of at least one image forming area on the first surface for forming the image; and
an output unit that outputs information representing the set position of the at least one image forming area.

2. The information processing apparatus according to claim 1, wherein the image forming area setting unit sets a second reference position, which specifies a position in the transport direction of the at least one image forming area on the second surface, to a position determined based on a value obtained by adding or subtracting a length in the transport direction of the at least one image forming area on the first surface to or from a value obtained by subtracting a value representing a first reference position, which specifies a position in the transport direction of the at least one image forming area on the first surface, from the length in the transport direction of the recording medium.

3. The information processing apparatus according to claim 1, further comprising:
an acquiring unit that acquires information that represents the length in the transport direction of the recording medium and is output from the image forming apparatus that stores the recording medium.

4. The information processing apparatus according to claim 2, further comprising:
an acquiring unit that acquires information that represents the length in the transport direction of the recording medium and is output from the image forming apparatus that stores the recording medium.

5. The information processing apparatus according to claim 1, wherein if a number of the at least one image forming area on the first surface and a number of the at least one image forming area on the second surface satisfy a predetermined condition, the image forming area setting unit sets the position of the at least one image forming area on the second surface for each of pairs including one of the at least one image forming area on the first surface and one of the at least one image forming area on the second surface.

6. The information processing apparatus according to claim 2, wherein if a number of the at least one image forming area on the first surface and a number of the at least one image forming area on the second surface satisfy a predetermined condition, the image forming area setting unit sets the position of the at least one image forming area on the second surface for each of pairs including one of the at least one image forming area on the first surface and one of the at least one image forming area on the second surface.

7. The information processing apparatus according to claim 3, wherein if a number of the at least one image forming area on the first surface and a number of the at least one image forming area on the second surface satisfy a predetermined condition, the image forming area setting unit sets the position of the at least one image forming area on the second surface for each of pairs including one of the at least one image forming area on the first surface and one of the at least one image forming area on the second surface.

8. The information processing apparatus according to claim 4, wherein if a number of the at least one image forming area on the first surface and a number of the at least one image forming area on the second surface satisfy a predetermined condition, the image forming area setting unit sets the position of the at least one image forming area on the second surface for each of pairs including one of the at least one image forming area on the first surface and one of the at least one image forming area on the second surface.

9. An image forming system comprising:
an information processing apparatus including
an image forming area setting unit that, in formation of an image on a first surface of a recording medium and a second surface of the recording medium opposite to the first surface, sets a position of at least one image forming area on the second surface for forming the image such that the at least one image forming area on the second surface is separated in a transport direction, in which the recording medium is transported when the image is formed on the first surface in an image forming apparatus that forms an image, from an upstream end portion in the transport direction of the recording medium by a distance corresponding to a value obtained by subtracting from a length in the transport direction of the recording medium a distance in the transport direction from a downstream end portion in the transport direction of the recording medium to an upstream end portion in the transport direction of at least one image forming area on the first surface for forming the image, and
an output unit that outputs information representing the set position of the at least one image forming area; and
the image forming apparatus that forms the image in the at least one image forming area on the second surface of the recording medium at the position represented by the output information.

10. A non-transitory computer readable medium storing a program causing a computer to execute information processing, the processing comprising:
in formation of an image on a first surface of a recording medium and a second surface of the recording medium opposite to the first surface, setting a position of at least one image forming area on the second surface for forming the image such that the at least one image forming area on the second surface is separated in a transport direction, in which the recording medium is transported when the image is formed on the first surface in an image forming apparatus that forms an image, from an upstream end portion in the transport direction of the recording medium by a distance corresponding to a value obtained by subtracting from a length in the transport direction of the recording medium a distance in the transport direction from a downstream end portion in the transport direction of the recording medium to an upstream end portion in the transport direction of at least one image forming area on the first surface for forming the image; and
outputting information representing the set position of the at least one image forming area.

11. An information processing method comprising:
in formation of an image on a first surface of a recording medium and a second surface of the recording medium opposite to the first surface, setting a position of at least one image forming area on the second surface for forming the image such that the at least one image forming area on the second surface is separated in a transport direction, in which the recording medium is transported when the image is formed on the first surface in an image forming apparatus that forms an image, from an upstream end portion in the transport direction of the recording medium by a distance corresponding to a value obtained by subtracting from a length in the transport direction of the recording medium a distance in the transport direction from a downstream end portion in the transport direction of the recording medium to an upstream end portion in the transport direction of at least one image forming area on the first surface for forming the image; and
outputting information representing the set position of the at least one image forming area.
